(19) United States
(12) Patent Application Publication
(10) Pub. No.: US 2014/0259713 A1
(43) Pub. Date: Sep. 18, 2014

(54) PRODUCT MEASUREMENT TOOL AND METHOD OF MEASURING AN OBJECT

(71) Applicant: PERDUE FOODS LLC, Salisbury, MD (US)

(72) Inventor: Philip E. Nichols, Salisbury, MD (US)

(73) Assignee: Perdue Foods LLC, Salisbury, MD (US)

(21) Appl. No.: 13/837,568

(22) Filed: Mar. 15, 2013

(51) Int. Cl. G01B 5/02

(52) U.S. Cl. CPC G01B 5/02
USPC 33/427

(57) ABSTRACT

A square area measurement tool includes a plurality of vertical panels, each of which is connected to two other panels on opposing ends, configured perpendicularly, and independently movable relative to the other panels. A primary ruled component on a planar surface of at least two of the vertical panels provides measurements in two dimensions of an object within the measurement tool. The panels are connected to one another by a connection knob for engaging a connection knob retaining slot of an adjacent panel. A method for measuring an object involves inserting the object into a measurement tool and sliding the panels toward each other until the vertical panels contact the object. A method for determining a minimum footprint of a plurality of products comprises inserting at least two products in various relative orientations in the measurement tool and measuring the orientations until a smallest square area is identified.

### FIELD OF THE INVENTION

The present invention is directed to the field of measurement of food products or irregularly shaped objects.

### BACKGROUND OF THE INVENTION

The storage of large quantities of food products, such as packaged meat and poultry, on wholesale or retail merchant's shelves requires that the dimensions of food products, especially those in irregular and/or non-rigid containers, are accurately measured to ensure that adequate shelf space is allocated for their placement, storage, and display. To ensure the food products meet prescribed specifications, they can be measured to characterize selected parameters, such as size, shape, area, volume, or thickness. These physical characteristics of food products can be critical for customer acceptance of the product and also may lend themselves to the quality of the product.

Some product measurement methods involve such crude size measurements as using a ruler, which can be time consuming and lack precision. A definitive numerical precision for merchants to plan product display and for product packagers to design product packaging is needed.

### SUMMARY OF THE INVENTION

A measurement tool includes a first vertical panel, a second vertical panel, a third vertical panel and a fourth vertical panel. Each vertical panel is connected perpendicularly to two other panels and is movable relative to the other panels. A primary ruled component is on a planar surface of at least two of the vertical panels. A connection knob is on a vertical edge of the vertical panels. A connection knob retaining slot is formed in the planar surface of a vertical panel of each one of the vertical panels. When the tool is assembled, the connection knob is received inside the connection knob retaining slot formed in an adjacent vertical panel.

A method of measuring an object includes the steps of inserting the object into a measurement tool having a plurality of vertical panels that form a rectilinear enclosure that is enclosed on at least four sides, and sliding the plurality of vertical panels toward each other until the vertical panels contact the object. Contact of the vertical panels with the object provides a measurement of length and width of the object. It is possible to measure non-rigid objects, which are objects that change shape in response to a shift in position or in response to internal or external pressure applied to the object. This is in contrast to a rigid object, which is an object that retains a uniform shape in any position and throughout application of internal or external pressure.

A method for determining a minimum footprint of a plurality of products includes the steps of inserting a product (or multiple products, such as two products) in a first relative orientation into a measurement tool having a plurality of vertical panels that form a rectilinear enclosure that is enclosed on four sides; moving the plurality of vertical panels toward each other until the vertical panels contact the product(s); measuring length and width of the product(s) in the first relative orientation using a ruled device; and repositioning the product(s) in other relative orientations and repeating the moving and measuring steps until a smallest square area is identified. This method is especially useful when measuring at least two irregularly shaped objects simultaneously.

### DESCRIPTION OF THE DRAWINGS

FIG. 1 is a perspective view of a measurement tool according to an embodiment of the present invention;

FIG. 2a is a perspective view of an interior surface of one of the vertical panels of the measurement tool shown in FIG. 1;

FIG. 2b is a perspective view of an exterior surface of the vertical panel shown in FIG. 2a,

FIGS. 3a and 3b are perspective views of an alternative embodiment of the measurement tool, respectively showing a ruler for measuring product height mounted to the measurement tool and separate from the measurement tool; and

FIG. 4 is a perspective view of a plurality of vertical panels of the measurement tool in preparation for connection to each other.

### DETAILED DESCRIPTION OF THE INVENTION

FIG. 1 shows an embodiment of the disclosed measurement tool 2. The measurement tool defines an interior product measurement space 26, which is in the shape of a rectangular prism. The measurement tool 2 includes a first vertical panel 4, a second vertical panel 6, a third vertical panel 8 and a fourth vertical panel 10. Each of the vertical panels is connected to two other panels in a perpendicular orientation and opposes and is parallel to one other panel. For example, a first vertical panel 4 is adjacent to second vertical panel 6 and fourth vertical panel 10 and opposes and is parallel to third vertical panel 8. Each panel is perpendicular to a surface on which the panel rests. Each of the vertical panels is detachable from an adjoining vertical panel and each panel is movable relative to the other panels. For example, first vertical panel 4 is movable relative to second vertical panel 6 and third vertical panel 8, when first vertical panel 4 is moved with fourth vertical panel 10 as fourth vertical panel 10 moves toward or away from second vertical panel 6. Similarly, first vertical panel 4 is movable relative to fourth vertical panel 10 and third vertical panel 8, when first vertical panel 4 is moved with second vertical panel 6 as first vertical panel 4 moves toward or away from third vertical panel 8. Movement of one panel relative to an adjacent panel is when a first panel remains stationary and a second panel is allowed to be adjusted. When assembled, adjacent panels are movable relative to one another along a first axis, but not along a second axis perpendicular to the first axis. For example, first vertical panel 4 can move relative to fourth vertical panel 10 along the axis of the connection knob retaining slot 18 of fourth vertical panel 10, but these two panels move with one another when first vertical panel 4 is moved in a direction transverse to the axis of the connection knob retaining slot 18 of fourth vertical panel 10.

A primary ruled component 12 is on a planar surface of at least two of the vertical panels. The measurement tool is not limited to having a ruled component on two of the vertical panels. It is possible and, in some cases, preferable to have a ruled component on a planar surface of three or even all four of the vertical panels. As shown in FIG. 1, the first vertical panel 4 has a primary ruled component 12 on an upper portion of the panel's exterior surface. Similarly, the fourth vertical panel 10 also has a primary ruled component 12 on an upper portion of the panel's exterior surface. The primary ruled component 12 is on a side of the vertical panel opposite the product measurement space 26. However, exterior placement of the primary ruled component 12 is not a requirement as a ruled component can be placed on an interior surface of the vertical panel 4 instead of or in addition to the exterior ruled component.

With reference to FIGS. 2a and 2b, a connection knob 14 is formed on a vertical edge 16 of each of the vertical panels. A connection knob retaining slot 18 is formed in the planar surface of each one of the vertical panels. When the measurement tool is assembled for use, the connection knob 14 is received inside the connection knob retaining slot 18. A biasing means 20 can be placed inside the connection knob retaining slot 18 to bias the connection knob away from the biasing means 20 with a pushing force or toward the biasing means 20 with a pulling force. The biasing means 20 can be a helical spring, a leaf spring, a pneumatic device, or any other device capable of urging a vertical panel toward or away from a resting position. For purposes of the present invention, when a maximum product size is desired, it is preferable that the vertical panels be biased toward each other, i.e., toward the product measurement area 26. Biasing aids against slippage of one vertical panel relative to an adjacent vertical panel.

As shown in FIG. 1, each vertical panel is made of an upper component 34 and a lower component 36. As shown in FIGS. 2a and 2b, the vertical panel is monolithic. There is no restriction on the assembly of the vertical panels. The vertical panel material is preferably plastic and can be opaque, translucent or transparent.

The connection knob is rectangular in cross-section and maintains its respective vertical panel at an upright angle, preferably generally 90°, from the plane of the surface on which the measurement tool rests. However, the connection knob 14 is not necessarily restricted to a rectilinear configuration as shown in the Figures. The connection knob 14 preferably has straight edged sides to help maintain the vertical panel in an upright configuration relative to an adjoining vertical panel. The connection knob 14 can be circular or otherwise have curved edges. The knob should fit snuggly enough inside of the connection knob retaining slot 18 to maintain the vertical panel in an upright configuration.

The connecting knob 14 is attached to a vertical panel via a connecting neck 22. The connecting neck 22 shown in the figures is rectangular in cross-section. The rectangular cross-sectional shape further helps to keep the vertical panel in an upright configuration relative to the adjoining vertical panels and to the surface on which the tool rests. A connection knob locking element 24, such as a butterfly nut 24 in cooperation with a bolt, can be added to maintain a position of one vertical panel relative to an adjoining vertical panel. Such a locking element can be configured to limit the travel distance of any of the vertical panels or can be configured to lock any of the vertical panels in a particular position. When used to limit the travel distance of a vertical panel, the connection knob locking element is outside of the measurement tool's product measurement area 26, for instance when a maximum product size must be adhered to. Conversely, the locking element 24 would be inside the product measurement area 26 if a minimum size measurement is necessary. When used to lock the vertical panel in a particular position, the connection knob locking mechanism can be positioned on the edge 16 of the vertical panel such that it engages a through hole or slot (not shown) in an adjoining vertical panel.

As shown in the figures, the ruled component 12 is a ruler that is embedded in or written on a surface of the vertical panel. However, the embodiment can also include an after market ruler that is attached via snaps, clips or some other fastening means to the vertical panel. As shown in FIG. 2b, a third ruled component 30a is added to an interior surface 32 of one of the vertical panels. The third ruled component 30a is configured either vertically or horizontally inside the product measurement area 26 so that the product's height or width can be easily determined. Alternatively, and especially in the case of transparent vertical surfaces, a ruled component 30b is placed exterior to the product measurement area 26. In this case, as shown in FIG. 2b, the third ruled component 30b can be rotatably coupled to an exterior of one of the vertical panels so that the third ruled component 30b can be stowed if a product height measurement is unnecessary. In operation, the rotatable third ruled component 30b is rotatable to an orthogonal position relative to the primary ruled component 12.

FIGS. 3a and 3b show an alternative embodiment of the measurement tool. A third ruled component 30c removably engages an anchoring slot 38. The length of the anchoring slot 38 is sized so that the third ruled component 30c extends all the way to the bottom of the measurement tool. Thus, accurate height measurements are possible when a product is in the product measurement space 26. When a third dimension is not needed or if disassembly of the measurement tool is desired, the third ruled component 30c can be removed from the anchoring slot 38.

The planar surface of each of the vertical panels should preferably contain no discontinuities throughout a length and height thereof. A lack of discontinuities is helpful when measuring objects that are not stiff, that have an irregular shape or protrusions, or that have a non-rigid, variable shape that depends on the pressure applied to the object. By “irregular shape,” it is meant that an object is anything other than rectilinear.

With further reference to FIG. 1, a distance between a first random point on the planar surface and a first corresponding point on an opposing, parallel vertical panel is equal to a distance between a second random point on the planar surface and a second corresponding point on the opposing, parallel vertical panel. As such, a measurement obtained at the lower half of the measurement tool will be consistent with a measurement obtained at the top half of the measurement tool. Such measurement consistency is partially enabled by the connection knob 14 in combination with the connection knob retaining slot 18. The resulting shape of the measurement tool when all four vertical panels, 4, 6, 8, and 10 are connected is a rectilinear enclosure that is enclosed on four sides (i.e., enclosed due to the lack of discontinuity in the surfaces of the vertical panels). The interconnection between all of the vertical panels is more easily understood with reference to FIG. 4. FIG. 4 shows all of the vertical panels 4, 6, 8 and 10 of the measurement tool in position prior to assembly. Interconnection of the panels will result in the measurement tool shown in FIG. 1.

To use the measurement tool described above, a person inserts an object to be measured into the interior of a measurement tool that, as disclosed above, has a plurality of vertical panels that form a rectilinear disclosure that is enclosed on all sides. Although FIG. 1 shows a measurement tool having four sides, it is possible to have a measurement tool with fewer or more than four sides. The product measurement space 26 receives the object that is inserted into the measurement tool. The boundaries of the product measurement space 26 are defined by the sides of the measurement tool (i.e., vertical panels). The plurality of vertical panels are slid toward each other until the vertical panels contact the product to be measured. Contact of the vertical panels with the object provides a measurement of length and width of the object. Measurements, representative of an object's maximum length and width, are taken at an intersection 28 (shown in FIG. 1) of two vertical panels.

The product measurement tool can be used to measure rigid and non-rigid objects. A non-rigid object is an object that changes shape in response to a shift in the non-rigid object's position or in response to internal or external pressure applied on the object. A rigid object is an object that retains a uniform shape in any position and throughout application of internal or external pressure. For example, a bag containing unfrozen chickens or fish or other food product would be considered a non-rigid object, and a bag containing thoroughly frozen chicken, fish or other food product would be considered a rigid object.

To determine a minimum footprint of a product or of a plurality of products, a person should insert the product or products in a first relative orientation into the measurement tool, which, as already described above, has a plurality of vertical panels that form an enclosed rectilinear enclosure. The plurality of vertical panels are pressed toward each other until the vertical panels contact the product or products and a ruled device is used to measure a length and a width of the product or products. The product is repositioned within the measurement tool multiple times until a smallest square area is determined. If measuring a plurality of products, the products are repositioned within the square area measurement tool and/or into further relative orientations with respect to each other multiple times until a smallest square area is determined. This method is especially useful when measuring at least two irregularly shaped objects. In everyday use, the term “footprint” typically means the surface area of an object that is in contact with a surface on which the object rests. However, for purposes of the present disclosure, the term “footprint” means the widest possible area of an object in a plane perpendicular to the vertical panels. For example, a ball having a diameter of twelve inches has small surface area in contact with the surface on which the ball is resting, relative to the diameter of the ball. However, at least for the purposes of the present disclosure, the ball would have a footprint of a circle with a diameter of twelve inches.

It is conceivable that the methods disclosed herein can be automated. For example, motion of each vertical panel relative to another vertical panel can be motorized. Also, measurements can be taken using a light beam or electronic distance measurement tool, instead of a ruler.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A measurement tool comprising:
a first vertical panel, a second vertical panel, a third vertical panel and a fourth vertical panel, each panel connected perpendicularly to two other panels and is movable relative to the other panels;
a primary ruled component on a planar surface of at least two of the vertical panels which are adjacent to one another;
a connection knob on a vertical edge of the vertical panels; and
a connection knob retaining slot formed in the planar surface of each one of the vertical panels;
wherein the connection knob of each of the vertical panels is adapted to be received in the connection knob retaining slot in an adjacent vertical panel.

2. The measurement tool as recited in claim 1 further comprising a third ruled component for providing measurement of a height dimension of an object.

3. The measurement tool as recited in claim 2, wherein the third ruled component is a ruler rotatably coupled to one of the vertical panels.

4. The measurement tool as recited in claim 2, wherein the third ruled component is orthogonal to the primary ruled component.

5. The measurement tool as recited in claim 1, wherein the connection knob is rectangular in cross-section and configured to maintain the vertical panels at an upright angle.

6. The measurement tool as recited in claim 5 further comprising a connecting neck for connecting the connecting knob to the vertical panel in which is formed the connection knob retaining slot adapted to receive the connecting knob.

7. The measurement tool as recited in claim 6, wherein the connecting neck is rectangular in cross-section.

8. The measurement tool as recited in claim 7, wherein the planar surface of each of the vertical panels contains no discontinuities throughout the length and height thereof.

9. The measurement tool as recited in claim 1 further comprising a biasing element for urging the connection knob within the slot in a selected direction.

10. The measurement tool as recited in claim 9 further comprising a connection knob locking element for maintaining a position of one vertical panel relative to an adjacent vertical panel.

11. The measurement tool as recited in claim 1, wherein each of the vertical panels is detachable from an adjoining vertical panel.

12. The measurement tool as recited in claim 1, wherein a distance between a first random point on the planar surface and a first corresponding point on an opposing, parallel vertical panel is equal to a distance between a second random point on the planar surface and a second corresponding point on the opposing, parallel vertical panel.

13. The measurement tool as recited in claim 12, wherein the plurality of vertical panels form a rectilinear enclosure that is enclosed on four sides.

14. A method of measuring an object comprising:
inserting the object into a measurement tool having a plurality of vertical panels that form a rectilinear enclosure that is enclosed on four sides; and
sliding the plurality of vertical panels toward each other until the vertical panels contact the object;
wherein the contact of the vertical panels with the object provides measurements of length and width of the object.

15. A method of measuring an object as recited in claim 14, wherein the object is a non-rigid object that changes shape in response to a shift in the non-rigid object's position or in response to internal or external pressure applied to the object.

16. A method measuring an object as recited in claim 14, wherein the object is a rigid object that retains its shape in any position and throughout application of internal or external pressure.

17. A method for determining a minimum footprint of a plurality of products comprising:
inserting at least two products in a first relative orientation into a measurement tool having a plurality of vertical panels that form a rectilinear enclosure that is enclosed on four sides;
moving the plurality of vertical panels toward each other until the vertical panels contact the at least two products;
measuring length and width of the at least two products in the first relative orientation using a ruled device; and
repositioning the at least two identical products in at least one additional relative orientation and repeating the moving and measuring steps to identify a smallest square area.

18. The method for determining a minimum footprint of a plurality of products as recited in claim 17, wherein the at least two identical products are irregularly shaped.

19. A square area measurement tool comprising:
a first vertical panel, a second vertical panel adjacent to the first vertical panel, a third vertical panel adjacent to the second vertical panel and opposing and parallel to the first vertical panel, and a fourth vertical panel adjacent to the third and first vertical panels and opposing and parallel to the second vertical panel, each of the vertical panels being perpendicular to an adjacent vertical panel and at least two adjacent of the vertical panels comprising a primary ruled component on a planar surface thereof;
a connection knob on a vertical edge of each of the vertical panels;
a connection knob retaining slot formed in the planar surface of each of the vertical panels for receiving the connection knob of an adjacent vertical panel; and
wherein the connection knob is connected to each vertical panel via a connecting neck, the connecting knob and connecting neck are rectangular in cross section and configured to maintain the vertical panels at an upright angle;
wherein the planar surface of each of the vertical panels contains no discontinuities throughout a length and height thereof;
wherein each of the vertical panels is detachable from an adjoining vertical panel; and
wherein the vertical panels form a rectilinear enclosure that is enclosed on four sides.

20. The square area measurement tool as recited in claim 19 further comprising a ruler rotatably coupled to one of the vertical panels for providing a height measurement.
